(19) United States
(12) Patent Application Publication
(10) Pub. No.: US 2014/0316750 A1
(43) Pub. Date: Oct. 23, 2014

(54) DENTAL RESTORATION

(71) Applicant: DigitalPrep Technologies, Inc., West Valley City, UT (US)

(72) Inventors: Yunoh Jung, Sandy, UT (US); Daniel Yonil Jung, Sandy, UT (US)

(73) Assignee: DigitalPrep Technologies, Inc., West Valley City, UT (US)

(21) Appl. No.: 14/186,515

(22) Filed: Feb. 21, 2014

Related U.S. Application Data
(60) Provisional application No. 61/767,704, filed on Feb. 21, 2013.
(60) Provisional application No. 61/767,749, filed on Feb. 21, 2013.
(60) Provisional application No. 61/770,248, filed on Feb. 27, 2013.
(60) Provisional application No. 61/830,979, filed on Jun. 4, 2013.

(51) Int. Cl. A61C 1/08; A61C 13/00; A61C 9/00

(52) U.S. Cl. CPC A61C 1/082; A61C 9/004; A61C 13/0004
USPC 703/1

(57) ABSTRACT

A dental restoration technology is described. A file of a digital model of at least one tooth to undergo a dental restoration procedure is opened. A direction of a cut to be performed in the dental restoration procedure is selected. A bur is selected to be used in the dental restoration procedure. A cut line is drawn to be performed in the dental restoration procedure with the bur. A set of guide slots are generated that are remotely located laterally from the cut line. A cutting guide is modeled based in part on the digital model, the direction of the cut, the bur, the cut line, and the guide slots. A file of the cutting guide is saved.

### RELATED APPLICATIONS

This application claims the benefit of U.S. Provisional Application Ser. Nos. 61/767,704 and 61/767,749, filed Feb. 21, 2013; 61/770,248, filed Feb. 27, 2013; and 61/830,979, filed Jun. 4, 2013; which are hereby incorporated herein by reference.

### BACKGROUND

Dental restoration includes various dental procedures used to restore the function, integrity and morphology of a missing tooth structure. Dental bridges, crowns, and other prosthetic implants are examples of dental restoration procedures.

When dental restoration procedures are performed, for example bridges or crowns, generally the subject tooth or one or more adjacent teeth are modified by cutting and preparing the tooth for the prosthetic. The quality of the modification, including for example the cutting of the teeth, is largely dependent on the experience and precision of the dental professional performing the modification. An impression of the modified teeth may then be made and sent to a dental lab for the construction of the prosthetic. A temporary prosthetic may be used while the more permanent prosthetic is constructed, which may take several days or weeks.

### BRIEF DESCRIPTION OF THE DRAWINGS

FIG. 1 is a graphical user interface illustrating a digital model of a tooth to undergo a dental restoration procedure.

FIG. 2 is a component block diagram illustrating an example of a dental restoration system.

FIG. 3 illustrates an example of selecting an occlusal cut to be performed in a dental restoration procedure.

FIG. 4 illustrates an example of a cutting guide for use in a dental restoration procedure.

FIG. 5 illustrates an example of another cutting guide for making an occlusal cut.

FIG. 6 illustrates an example of undercut bumps on a cutting guide.

FIG. 7 illustrates an example of an X-ray computed tomography scan (CT scan) overlaid on a digital model of a tooth to undergo a dental restoration procedure.

FIG. 8 illustrates an example use of a cutting guide with a set of guide slots for guiding a hand piece with a bur attached.

FIGS. 9-10 are flowcharts illustrating example dental restoration methods.

FIG. 11 is block diagram illustrating an example of a computing device that may be used with dental restoration methods.

### DETAILED DESCRIPTION

Technology is described for performing dental restoration. In particular, the technology may allow users to perform dental restoration precisely and quickly. For example, after digitizing a dental impression a digital model may be prepared and a cutting guide may be designed using computer software. By utilizing such computer software, professionals may be able to make adjustments to the digital model prior to performing irreversible procedures. Further, cutting guides and prosthetics may be rapidly produced. For example, a three-dimensional printer may be employed to print out the cutting guide designed using the computer software. In this way, patient time is minimized, and temporary prosthetics may be unnecessary.

The technology may employ one or more computer systems. These computer systems, for example, may be operated in separate locations and linked together through a computer network such as the Internet. For example, part of the dental restoration procedure may be more readily handled at a dentist's office while a second part of the dental restoration procedure may be more readily handled at a dental lab. It may be easier for the patient to have a dental impression made at his local dentist's office, while prosthetic production may require tools not available to a local dentist's office. Indeed, this ability to perform separate parts of the dental restoration procedure at different physical locations may be facilitated through this technology by sending a prepared model from, for instance, a local dentist's office to a dental lab. This specialization and division of labor facilitated by the technology may help reduce patient and insurance costs throughout industry.

The technology may also allow generation of cutting guides that have guide slots that are remotely located laterally from a cut line. The cutting guide also may be modeled to fit adjacent teeth remove from the tooth undergoing dental restoration. In this way, an area above the tooth undergoing dental restoration may be substantially open. Heat, therefore, may be more readily dissipated into the ambient air. Moreover, the tooth may be easy to irrigate while also allowing for inspection by the dental professional during the cutting operation.

The technology may also include overlaying an X-ray computed tomography scan (CT scan) on the digital model. This may help facilitate design of the cutting guide and prosthetic. For example, a warning may be displayed in a graphical user interface when the software calculates that a cut line is encroaching upon tissue surrounding the tooth undergoing dental restoration. Thus, the technology may impact patient comfort and reduce surgical errors. Additionally, generated cutting guides may include an engraved piece of information about the dental restoration procedure. For example, the cutting guide may have a name of the patient undergoing the dental restoration procedure and the bur type to be used. Accordingly, surgical errors may further be reduced by minimizing the number of procedures being incorrectly performed on the wrong patient or with the wrong bur type, as a few non-limiting examples.

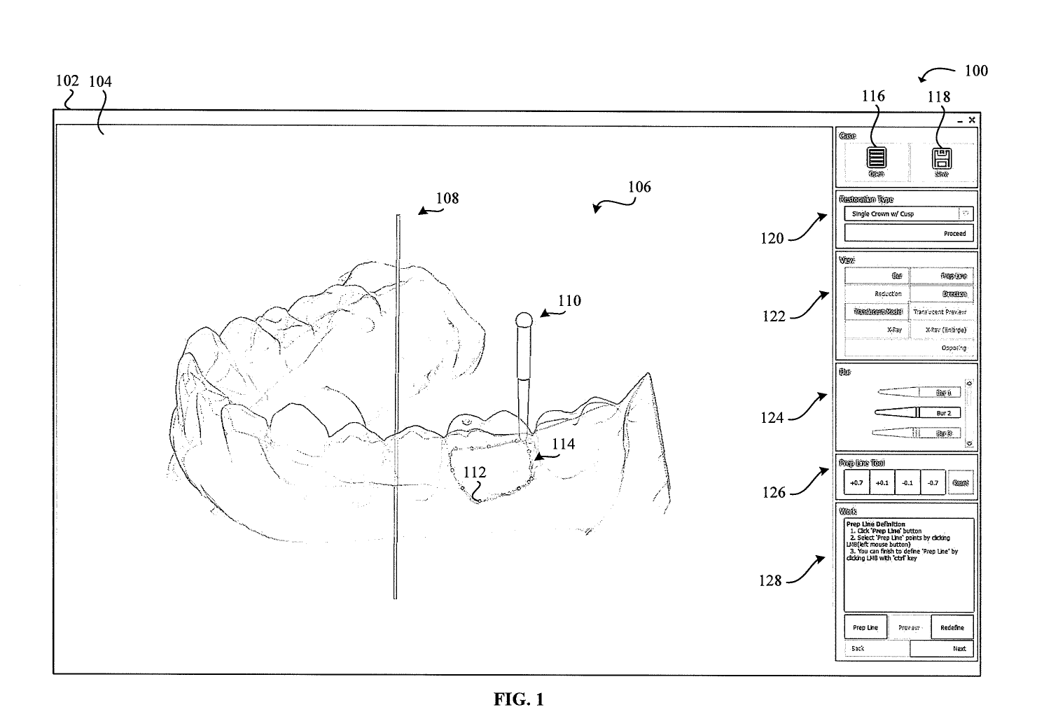

To more clearly describe the technology, examples are now provided with reference to the figures. Accordingly, FIG. 1 is a graphical user interface 100 illustrating a digital model 106 of a tooth 114 to undergo a dental restoration procedure. The graphical user interface 100 may include a graphical window 102 with a modeling area 104 adjacent to various tools and functions. The graphical user interface 100 may include an open file button 116 and a save file button 118, which may respectively open or save the digital model 106 displayed in the modeling area 104 of the graphical window 102. Thus, the graphical user interface 100 may allow a user to open a file of a digital model of at least one tooth to undergo a dental restoration procedure and/or save a file of the digital model and/or cutting guide. In some examples, the cutting guide may be saved in the same file as the digital model while in other examples the cutting guide may be saved and/or exported to a separate file. For example, the digital model 106 may be stored in a standard tessellation language (STL) based file format or other various formats suitable to store the information contained in the digital model 106.

The digital model may be initially generated by means of a dental impression and/or digital scan. For example, an initial dental impression may be made and digitized using a digital three-dimensional scanner. One way of producing such an initial dental impression may be by placing a viscous, thixotropic impression material into the mouth via a custom or stock dental impression tray. The material may then set and become an elastic solid. When removed from the mouth the elastic solid may provide a detailed and stable negative of teeth. Common materials used for dental impressions include sodium alginate, polyether and silicones.

Once removed from the mouth, the dental impression may be digitized through a three-dimensional scanning thereof. A three-dimensional scanner may generate a point cloud of geometric samples on the surface of the scanned impression. This point cloud may then be used to extrapolate, or reconstruct, the shape of the scanned impression. If the dental impression is scanned directly, this reconstructed shape may be negated to generate a positive shape of dental impression. That is, since the dental impression may be a negative impression of an individual's actual dental geometry, a direct scan may also result in a negative impression of the individual's actual dental geometry. This direct scan may be negated digitally. Alternatively, a negative impression may be used to form a positive impression of the individual's actual dental geometry, and the positive impression may then be scanned and utilized directly. In some examples multiple scans may be more accurate than a single scan. For instance, a single scan may not produce a complete model of the subject. Multiple scans, from many different directions may be required in order to obtain accurate information from several angles of the dental impression. These multiple scans may then be aligned and merged to create an accurate digitized dental impression.

The digital model 106 may have an image direction 108 set therein through use of an image direction setting tool. The image direction 108 may be in the occlusal direction, as one example. Several tools may be available in the graphical user interface 100. A user may use a dental restoration procedure selector 120 to select a dental restoration procedure from a set of predefined dental restoration procedures for the digital model 106. By selecting a dental restoration procedure, bur types, cut line drawing tools and possible insertion axes, amongst other things, may be changed and/or limited. Moreover, by selecting a dental restoration procedure the graphical user interface 100 may allow predefined functionality within the modeling area 104.

The graphical user interface 100 may also include a view panel 122 for enabling or disabling various views. As an example, a CT scan (also known as an ‘X-Ray’) may be enabled for overlay on the digital model 106.

A bur selection tool 124 may be used to select a bur for use in the dental restoration procedure, and a cut line (also known as a ‘prep line’) to be performed in the dental restoration procedure may be drawn using a drawing tool 126. Using the drawing tool 126, points may be placed within the digital model 106. For example, a string of points 112 may be placed at a base of the tooth 114 to form the cut line. In this way, drawing the cut may include placing multiple points within the digital model 106 such that they connect to form the cut line. The cut line may then be display as a whole on the digital model 106. The cut line may be in or out to increase the amount of tooth structure to be removed or preserved. Additionally, multiple views of the cut line may be presented in the graphical user interface 100. For example, the points may be placed on an interior portion of the digital model (e.g. within the tooth structure) while the cut line may be displayed on a surface portion of the digital model. In this way, the user may be able to see how the cut line looks on the surface of the tooth.

A direction of the cut to be performed in the dental restoration procedure may also be selected. A bur pin 110 may be initially placed based on the image direction 108 at the cut line around the tooth 114, for example. A user, however, may need to adjust the direction of the cut by moving the direction of the bur pin 110. For instance, the bur pin 110 may need to be adjusted to ensure that the cut to be performed in the dental restoration procedure does not impact teeth that neighbor the tooth 114. A CT scan overlaid on the digital model 106 (e.g. enabled using the view panel 122) may facilitate in determining a demarcation point between teeth in the digital model 106. Thus, an insertion axis selection tool (e.g. the bur pin 110) may be used to select an insertion axis for the bur for the dental restoration procedure within the digital model.

The graphical user interface 100 may also include a miscellaneous area 128 which may display textual feedback regarding use of the graphical user interface 100. Further the miscellaneous area 128 may include various buttons for interacting with the digital model 106. For example, a preview button when engaged may initiate a preview rendering tool that renders a preview of the digital model 106 with cuts applied. The applied cuts may be based in part on the occlusal direction, the cut line, the bur, and the insertion axis, for example. As discussed in further detail below, after previewing the digital model 106 a user may choose to generate a set of guide slots and model a cutting guide based in part on the digital model, the direction of the cut, the bur, the cut line and the guide slots, for example.

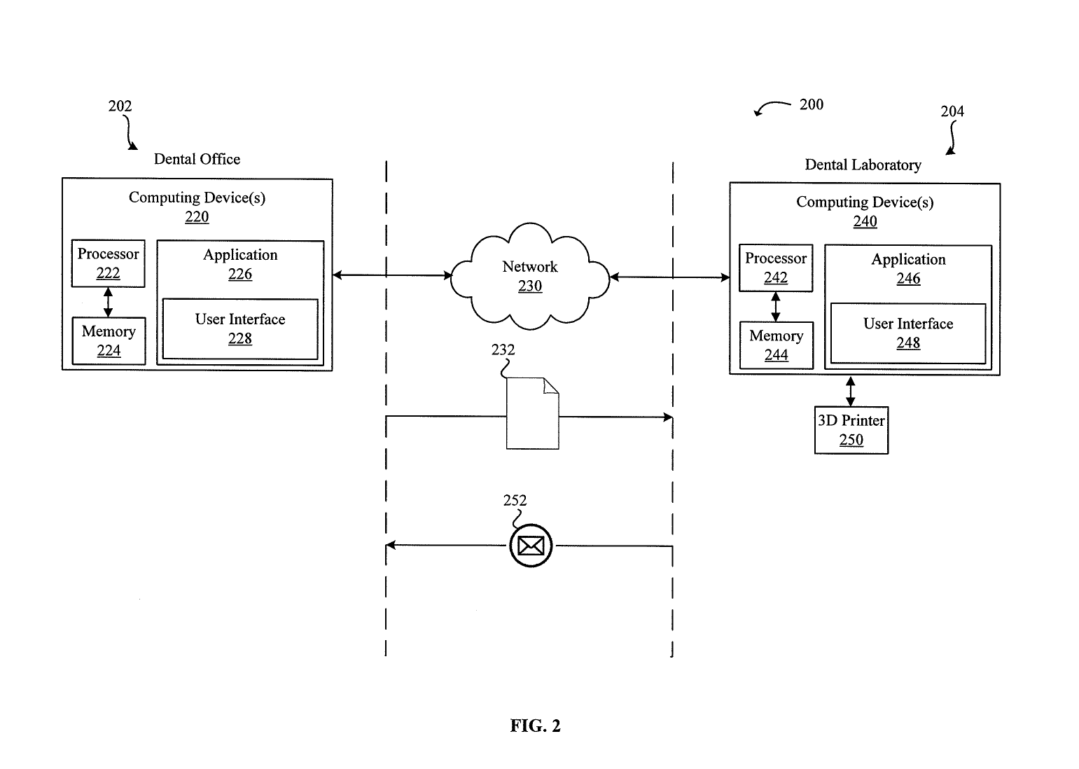

FIG. 2 is a component block diagram illustrating an example of a dental restoration system 200. The dental restoration system 200 includes a dental office 202 and a dental laboratory 204. The dental office 202 may be where a dental patient is diagnosed as needing a dental restoration procedure performed on one or more teeth. Additionally, the dental office 202 may use a computing device 220 as part of the dental restoration. For example, a dental professional may make a digital model of the patient's teeth. Using the software described with reference to FIG. 1 and with further details below, the dental professional may model the procedure with the software. In particular, in one example the dental professional may use an application 226 with a user interface 228 executing from a memory 224 on a processor 222 to model a cutting guide based in part on the digital model, the direction of the cut, the bur, the cut line and the guided slot.

The dental office 202 may be connected to the dental laboratory 204 through a network 230. In particular, the computing device 220 in the dental office 202 may be connected to a computing device 240 in the dental laboratory by way of the network 230. Thus a user at the dental office 202 (e.g. a dental professional) may send a file using the network 230, as illustrated by the in-transit file 232. A technician at the dental laboratory 204 may use the computing device 240 to run an application 246 with a user interface 248. The application 246 may reside in a memory 244 on the computing device 240 and may execute on a processor 242. The application 246 may be used to open and manipulate a file (e.g. the in-transit file 232 after being received). Additionally, the computing device 240 may be connected to a 3D printer 250 which may a 3D object that the file models. For example, a cutting guide may be printed using the 3D printer 250. The computing device 240 may also be used in milling a dental prosthetic to be used in a dental restoration associated with the cutting guide. As illustrated by the package 252, the dental laboratory 204 may send the cutting guide and/or dental prosthetic to the dental office 202. The dental office 202 may then use the cutting guide and/or dental prosthetic in performing a dental restoration procedure on the patient.

In one example, the 3D printer may engrave a piece of information associated with the dental restoration procedure on the cutting guide. For instance, a name of a dental professional performing the dental restoration procedure and/or the name of the patient having the dental restoration procedure may be embedded onto the cutting guide as part of the 3D printing process. In another example, an etching tool may engrave the piece of information onto the cutting guide after the cutting guide is printing. It may be desirable to include other information such as the bur to be used in the dental restoration procedure. Surgical errors may further be reduced by minimizing the number of procedures being. In this way, the technology may help minimize the number of dental restoration procedures incorrectly performed on the wrong patient or with the wrong bur type, for instance.

As discussed above, the applications 226 and 246 may include provide a digital model of one or more teeth. The digital model may be provided through a digital scan, for instance. In one example a CT scan may be overlaid on the digital model and may help facilitate modeling a correct cutting guide and/or prosthetic. Using the applications 226 and/or 246 the digital model may have an image direction set and a dental restoration procedure selected for the digital model. Using the applications 226 and/or 246 a cut line for the dental restoration procedure may be drawn within the digital model. Professional liability in various countries may dictate that various setting within the digital model be performed by a dental professional in the dental office 202 using the computing device 220. Other countries may have different legal requirements such that the dental laboratory 204 may make changes to the various settings in the digital model using the computing device 240 For example, a technician at the dental laboratory 204 may notice that the cut line infringes on a neighboring tooth by a fraction of a millimeter and may move the cut line so that it does not impact the neighboring tooth. Thus, some portions of the dental restorations methods may be performed on the computing device 220 while others may be performed on the computing device 240. Accordingly, using the applications 226 and/or 246 a bur for the dental procedure may be selected in the digital model and an insertion axis for the bur may be selected. Lastly, as discussed above the applications 226 and/or 246 may model a cutting guide for the dental restoration procedure within the digital model based in part on the image direction, the cut line, the bur and the insertion axis.

Within the digital model, additional empirical data may be overlaid onto the reconstructed shape of the scanned impression. For example, nerve depth may be digitally overlaid onto the image. Average nerve depth and a standard deviation thereof, for instance, may be known and overlaid based on the scanned depth of a given tooth. Deviation from the average nerve depth may be represented through various shades of colors. Red color, for instance may indicate the average nerve depth, while a blue color may represent the minimum standard deviation depth. Directional information may also supplement the digitized dental impression. In this way, verification may be made of the dental procedure within the applications 226 and/or 246.

The network 230 may include any useful computing network, including an intranet, the Internet, a local area network (LAN), a wide area network (WAN), a wireless data network, or any other such network or combination thereof, and may utilize a variety of protocols for transmission thereon, including for example, Internet Protocol (IP), the transmission control protocol (TCP), user datagram protocol (UDP) and other networking protocols. Components utilized for such a system may depend at least in part upon the type of network and/or environment selected. Communication over the network may be enabled by wired or wireless connections and combinations thereof.

The computing devices 220 and 240 may be devices such as, but not limited to, a desktop computer, a laptop, a tablet, a mobile device, a television, a cell phone, a smart phone, a hand held messaging device, a set-top box, a gaming console, an electronic book reader or any device with a display that may receive and present the information described above. Further, the computing devices 220 and 240 may comprise, for example, a server computer or any other system providing computing capability. Alternatively, a plurality of computing devices may be employed that are arranged, for example, in one or more server banks or computer banks or other arrangements. For purposes of convenience, the computing devices 220 and 240 may be referred to in the singular, but it is understood that a plurality of computing devices may be employed in various arrangements as described above.

Various processes and/or other functionality, as discussed herein, may be executed in the dental restoration system 200 according to various examples. A computing device may for example, provide some central server processing services while other computing devices may provide local processing services and interface processing services to interface with the services of a central computing device. Therefore, it is envisioned that processing services, as discussed herein, may be centrally hosted functionality or a service application that may receive requests and provide output to other services or customer devices.

For example, services may be considered on-demand computing that is hosted in a server, cloud, grid, or cluster computing system. An application program interface (API) may be provided for each service to enable a second service to send requests to and receive output from the first service. Such APIs may also allow third parties to interface with the service and make requests and receive output from the service. Like the various processing capabilities on the computing devices 220 and 240, processors 222 and 242 may provide processing instructions by communicating with memories 224 and 244 on the computing devices 220 and 240. That is, the memory device may include instructions operable to be executed by the processor to perform a set of actions.

Various data may be stored in a data store that is accessible to the computing devices 220 and 240. The term “data store” may refer to any device or combination of devices capable of storing, accessing, organizing and/or retrieving data, which may include any combination and number of data servers, relational databases, object oriented databases, cloud storage systems, data storage devices, data warehouses, flat files and data storage configuration in any centralized, distributed, or clustered environment. The storage system components of the data store may include storage systems such as a SAN (Storage Area Network), cloud storage network, volatile or non-volatile RAM, optical media, or hard-drive type media.

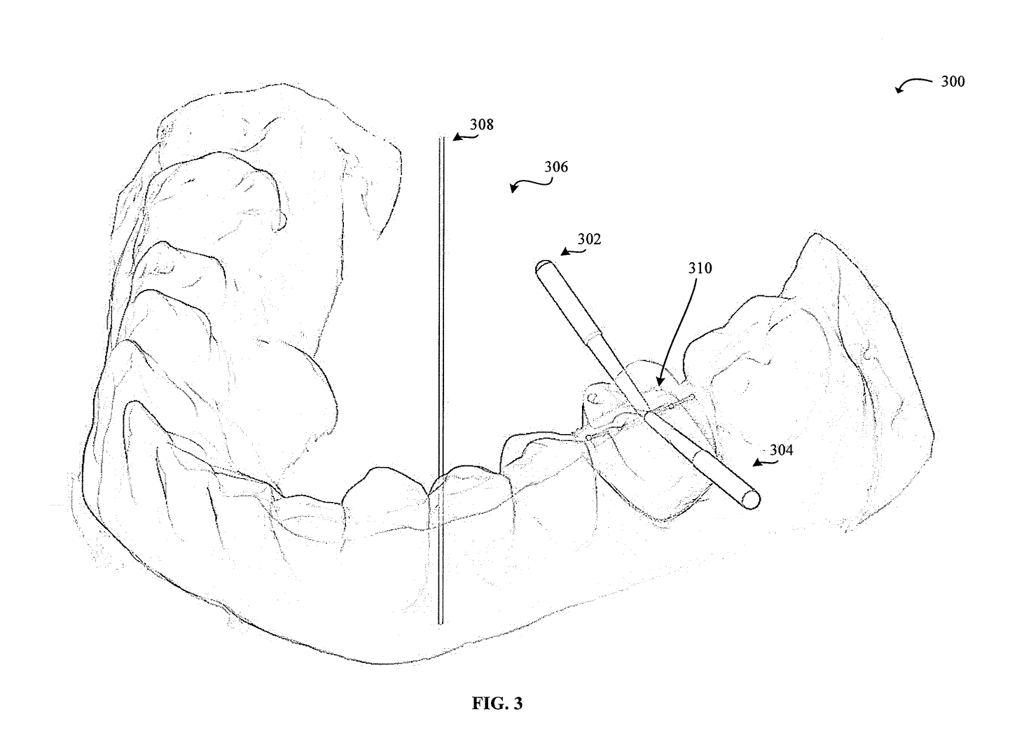

FIG. 3 illustrates an example 300 of selecting an occlusal cut to be performed in a dental restoration procedure. In doing so a digital model 306 may be provided and an image direction 308 may be set. On an occlusal cut, a pair of burs 302 and 304 may be selected to cut from opposing angles. Further, an insertion axis may be selected for the pair of burs 302 and 304. A cut line 310 may be drawn along a center portion of the tooth in the illustrated example. A graphical user interface of the digital model 306 may display a cut plane within the digital model. In one example positioning a pointer over a tip of one of the burs may cause the application to display the cut plane. In another feature of the application, a preview of the digital model with cuts applied may be rendered. The preview may be based in part on the image direction, the cut line, the bur and the insertion axis, for instance. Similarly, the application may also verify the dental restoration procedure. Cut depths may be analyzed against the digital model to ensure that the cuts to not reach nerves and cause unnecessary pain for the patient.

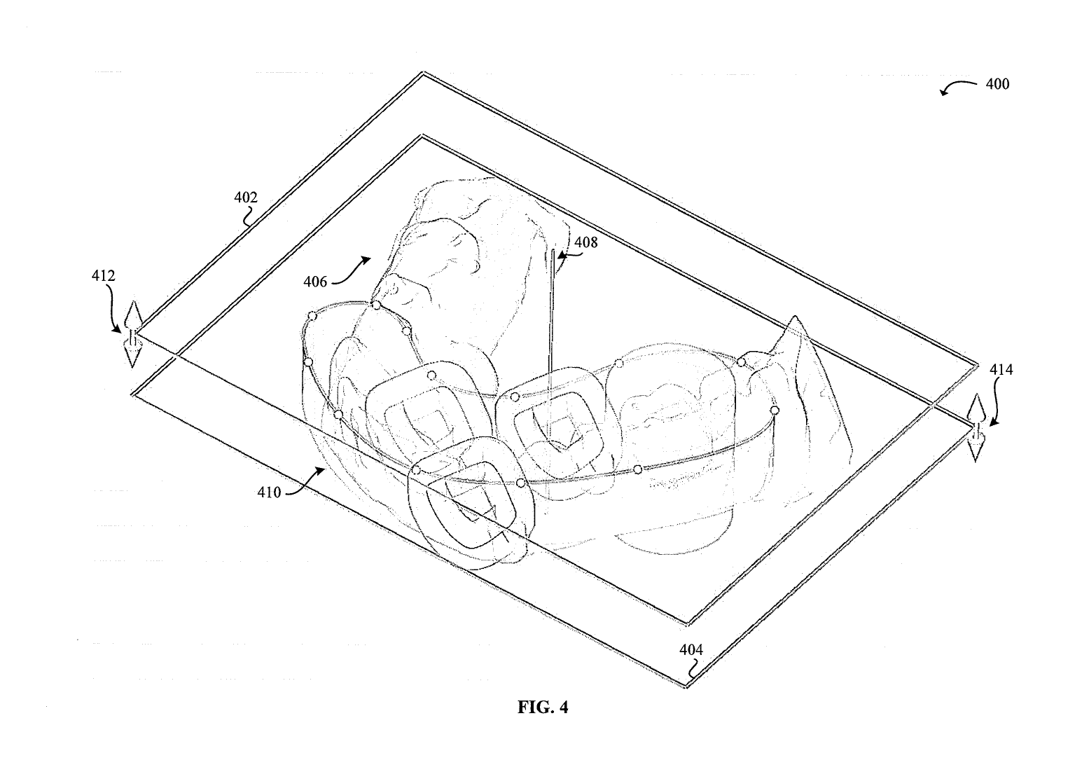

FIG. 4 illustrates an example 400 of a cutting guide 410 for use in a dental restoration procedure. The cutting guide 410 may be initially generated based in part on the digital model 406, the occlusal direction (e.g. the image direction 408), the cut line, the bur and the insertion axis. For example, a cutting guide generation tool in a graphical user interface may be engaged such that a cutting guide is produced based in part on the digital model, the occlusal direction, the cut line, the bur, and the insertion axis. However, the cutting guide 410 may be manipulated by a user of the application within the graphical user interface as desired. Placement of the cutting guide 410 may be manipulated in a horizontal direction through use of a pair of planes 402 and 404 with plane manipulation tools 412 and 414 respectively. In general, the cutting guide may include a set of guide slots. The guide slots may be remotely located laterally and spaced-apart from the cut line discussed above, as opposed to collinear and/or over the cut line. In doing so, the tooth undergoing dental restoration may be irrigated and fully inspected during the cutting operation.

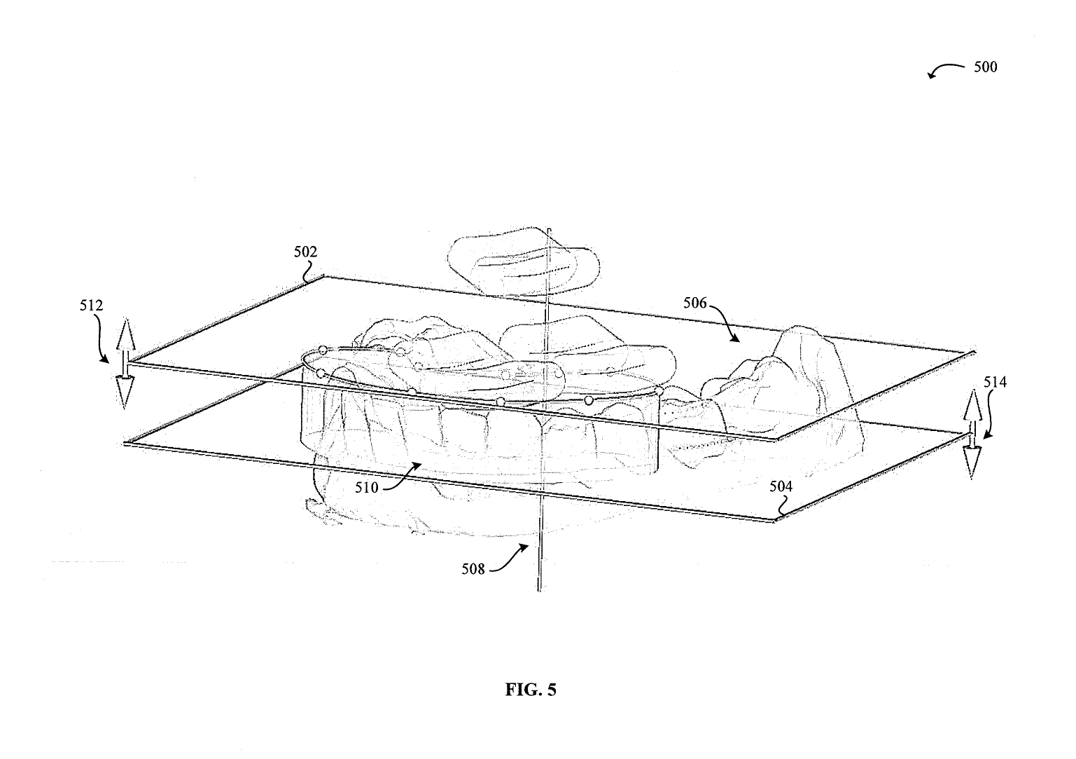

FIG. 5 illustrates an example 500 of another cutting guide 510 for making an occlusal cut. Similar to FIG. 4, the cutting guide 510 may be initially generated based in part on the digital model 506, the occlusal direction (e.g. the image direction 508), the cut line, the bur and the insertion axis. In an occlusal cut, a cut may be made on both side of the tooth towards a middle portion as illustrated and discussed with reference to FIG. 3. Similar to FIG. 4, the cutting guide 510 may be manipulated by a user of the application within the graphical user interface as desired. Placement of the cutting guide 510 may be manipulated in a horizontal direction through use of a pair of planes 502 and 504 with plane manipulation tools 512 and 514 respectively.

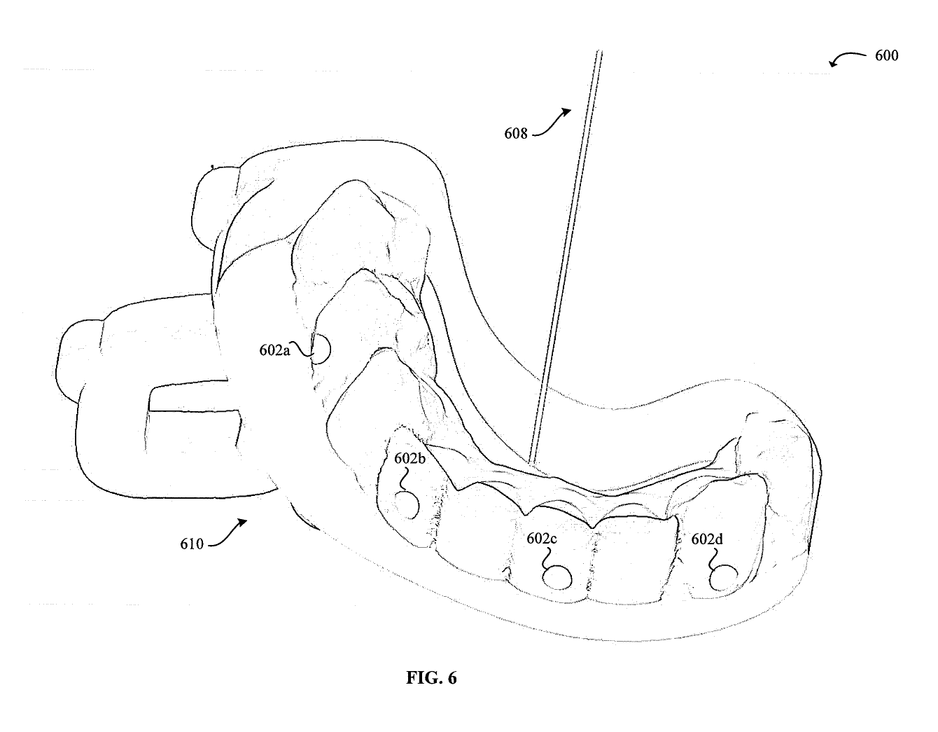

FIG. 6 illustrates an example 600 of undercut bumps 602a-d on a cutting guide 610. The cutting guide 610 may be based in part on a digital model with an image direction 608 set therein. The undercut bumps 602a-d may be placed against one or more teeth in the digital model to include the undercut bumps 602a-d on the cutting guide 610. In doing so, when the cutting guide 610 is 3D printed, the undercut bumps 602a-d may help hold the cutting guide in place while a dental professional perform the dental restoration procedure. Temporary cement or another adhesive may also be used with the cutting guide 610 to ensure that the cutting guide 610 remains stationary throughout the cutting procedure.

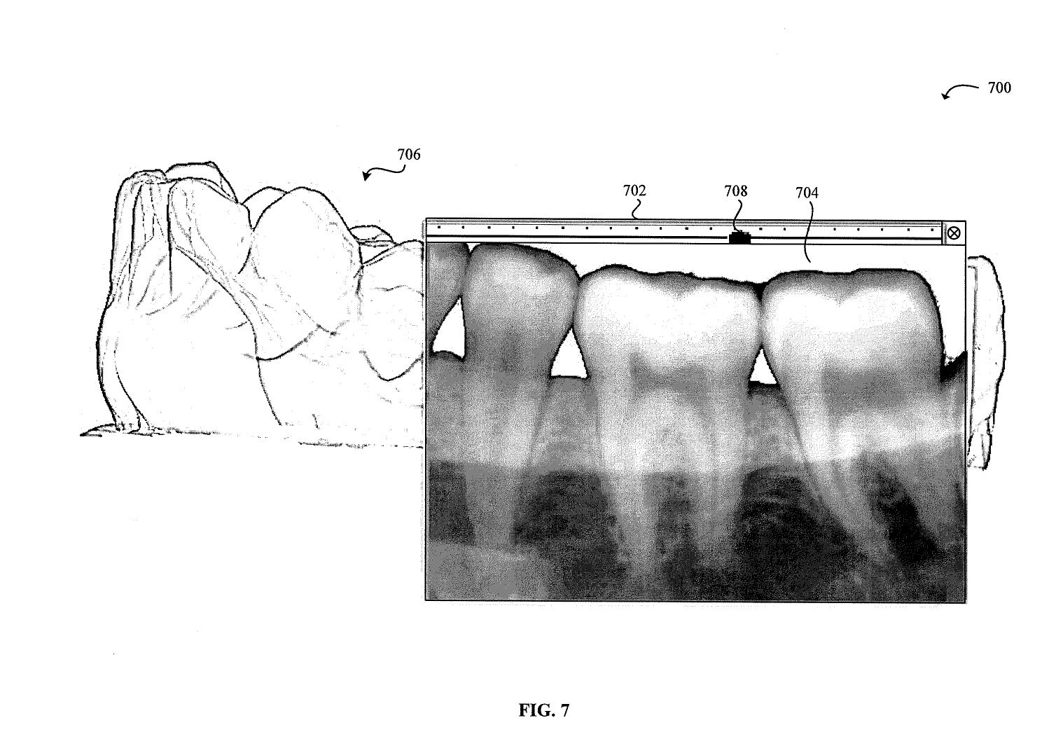

FIG. 7 illustrates an example 700 of an X-ray computed tomography scan (CT scan) 704 overlaid on a digital model of a tooth to undergo a dental restoration procedure. The CT scan may be provided in a window 702 with a sliding opacity scale 708. The CT scan 704 may be placed by adjusting the opacity with the sliding opacity scale 708 while resizing the window 702 to fit an underlying model 706. The underlying model 706 and/or the CT scan 704 may be rotated until the CT scan 704 fits approximately in the underlying model 706.

A dental professional may use the CT scan 704 as overlaid on a digital model (e.g. the underlying model 706) to verifying the dental restoration procedure in a graphical user interface. For instance, a warning may be displayed by a graphical user interface, and thereby viewed by the dental professional, when a cut encroaches upon tissue surrounding a as indicated by the CT scan 704.

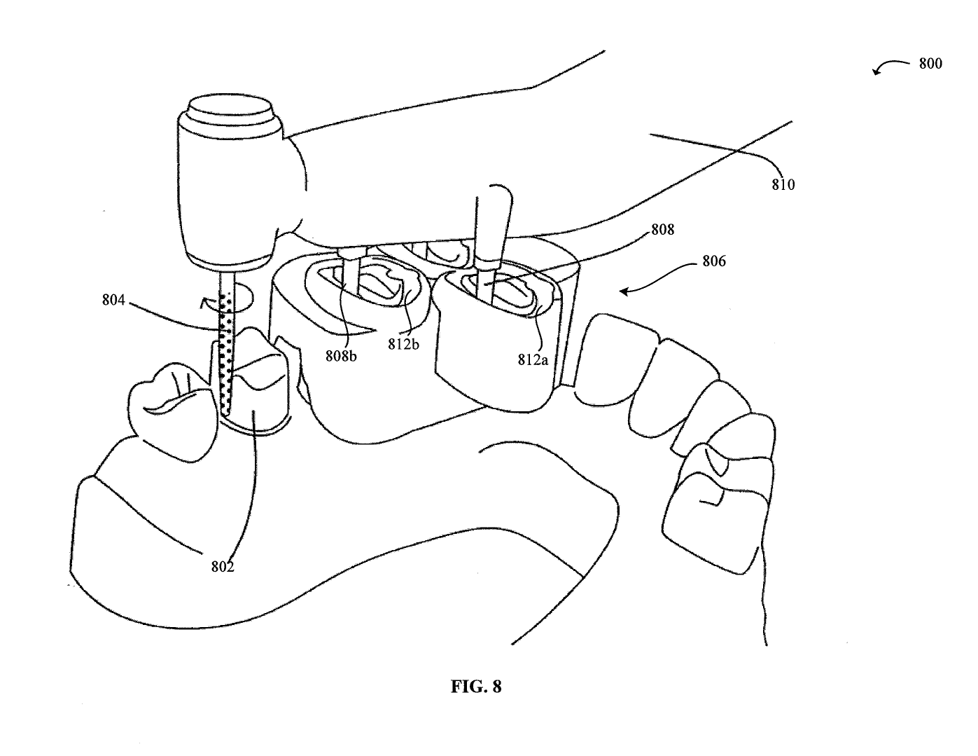

FIG. 8 illustrates an example 800 use of a cutting guide 806 with a set of guide slots for guiding a hand piece 810 with a bur 804 attached. The cutting guide 806 may include a set of guide slots 812a-b for a set of guide pins 808a-b to be guided with. The set of guide pins 808a-b may be coupled to a hand tool 810 for performing the cut. The hand tool 810 may further provide power to actuate the bur 804 rotationally in order to cut a tooth 802. The set of guide slots 812a-b may allow for effective irrigation and cooling of the tooth 802 during the cutting procedure.

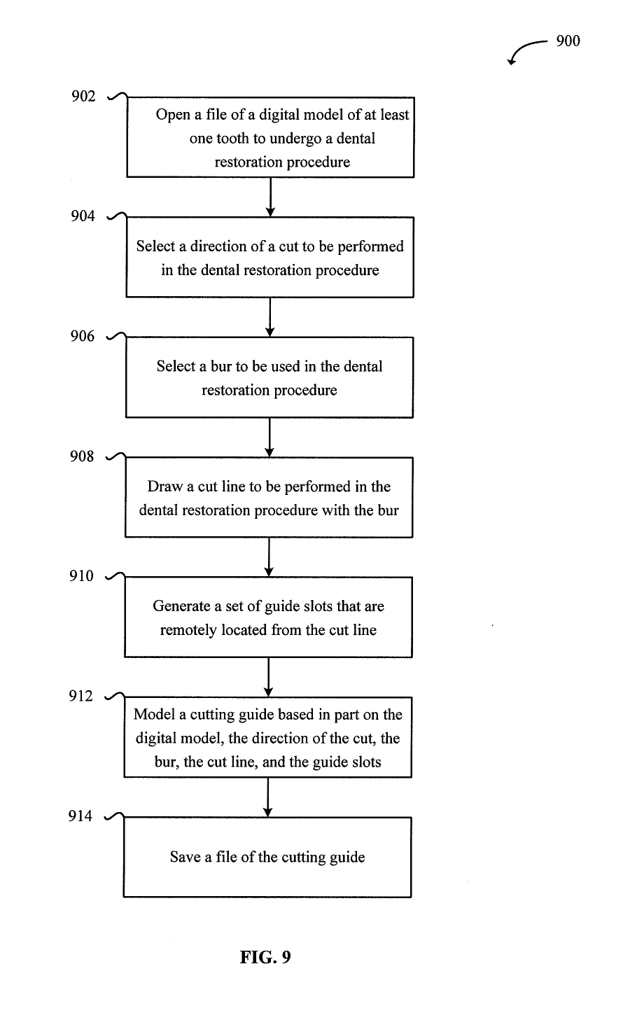

FIG. 9 is a flowchart illustrating an example dental restoration method 900. The dental restoration method 900 may include opening a file of a digital model of at least one tooth to undergo a dental restoration procedure, as shown in method element 902 and, selecting a direction of a cut to be performed in the dental restoration procedure, as shown in method element 904. The digital model may be stored in a standard tessellation language (STL) based file format, for example. In method element 906, a bur may be selected to be used in the dental restoration procedure. A bur may be a small, high-speed drill used during dental procedures such as shaping a tooth structure prior to the placement of a crown. The method 900 may further include drawing a cut line to be performed in the dental restoration procedure with the bur, as shown in method element 908. A warning may be displayed in a graphical user interface when it is calculated that a cut line is encroaching upon tissue surrounding the tooth undergoing dental restoration. A set of guide slots may be generated that are remotely located laterally from the cut line, as shown in method element 910. A cutting guide may then be model based in part on the digital model, the direction of the cut, the bur, the cut line, and the guide slots, as shown in method element 912, and a file of the cutting guide may be saved, as shown in method element 914.

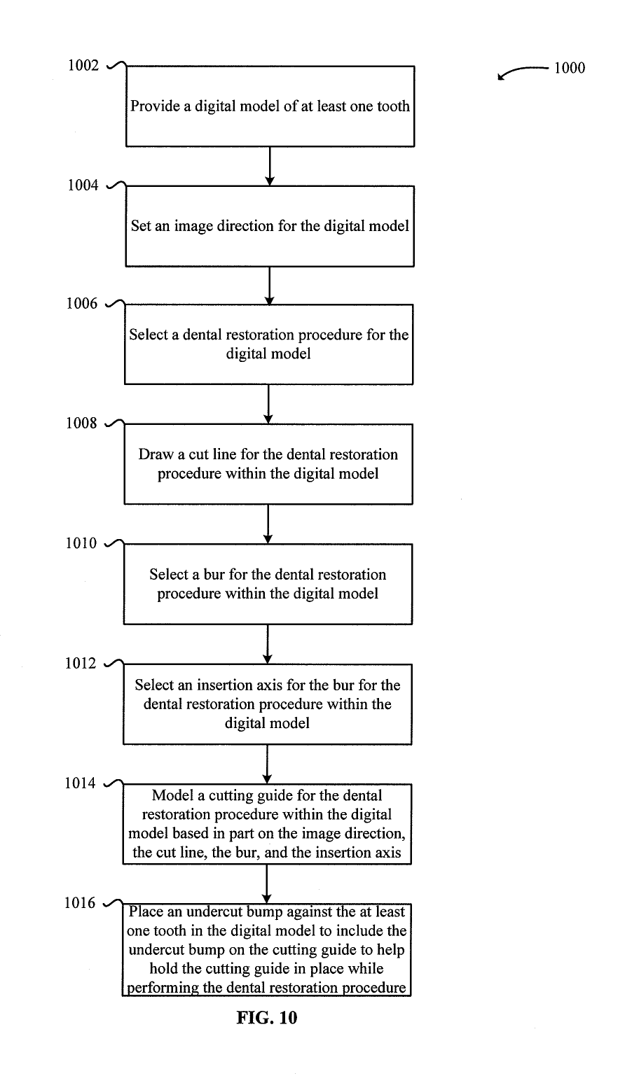

FIG. 10 is a flowchart illustrating an example dental restoration method 1000. The dental restoration method 1000 may include providing a digital model of at least one tooth, as shown in method element 1002, and setting an image direction for the digital model, as shown in method element 1004. An image direction setting tool may set the image direction to be the occlusal direction, for instance. The method 1000 may further include selecting a dental restoration procedure for the digital model, as shown in method element 1006. A cut line may be drawn for the dental restoration procedure within the digital model 1008. A bur may be selected for the dental restoration procedure within the digital model, as shown in method element 1010, and an insertion axis may be selected for the bur for the dental restoration procedure within the digital model, as shown in method element 1012. The method 1000 may further include modeling a cutting guide for the dental restoration procedure within the digital model based in part on the image direction, the cut line, the bur, and the insertion axis, as shown in method element 1014, and placing an undercut bump against the at least one tooth in the digital model to include the undercut bump on the cutting guide to help hold the cutting guide in place while performing the dental restoration procedure, as shown in method element 1016.

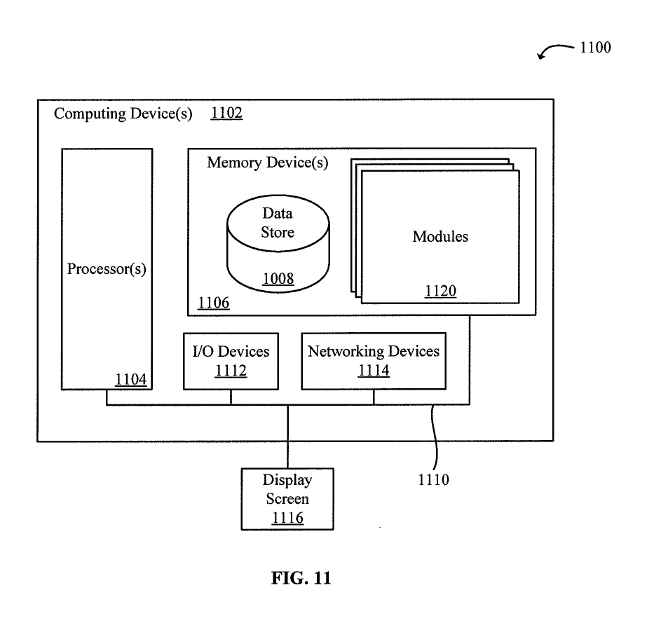

FIG. 11 is a block diagram illustrating an example of a computing device that may be used with dental restoration methods. In particular, the computing device 1102 illustrates a high level example of a device on which modules of the disclosed technology may be executed. The computing device 1102 may include one or more processors 1104 that are in communication with memory devices 1106. The computing device 1102 may include a local communication interface 1110 for the components in the computing device. For example, the local communication interface may be a local data bus and/or any related address or control busses as may be desired.

The computing device 1102, for instance, may be used by a dental professional and/or dental lab in the dental restoration methods described above. In particular, the memory device 1106 may contain modules 1120 that are executable by the processor(s) 1104 and data for the modules. The modules may execute the functions described earlier. A data store 1108 may also be located in the memory device 1106 for storing data related to the modules and other applications along with an operating system that is executable by the processor(s) 1104.

Other applications may also be stored in the memory device 1106 and may be executable by the processor(s) 1104. Components or modules discussed in this description that may be implemented in the form of software using high programming level languages that are compiled, interpreted or executed using a hybrid of the methods.

The computing device may also have access to I/O (input/output) devices 1112 that are usable by the computing devices. An example of an I/O device is a display screen 1116 that is available to display output from the computing devices. Other known I/O devices may be used with the computing device as desired. Networking devices 1114 and similar communication devices may be included in the computing device. The networking devices 1114 may be wired or wireless networking devices that connect to the internet, a LAN, WAN, or other computing network.

The components or modules that are shown as being stored in the memory device 1106 may be executed by the processor(s) 1104. The term “executable” may mean a program file that is in a form that may be executed by a processor 1104. For example, a program in a higher level language may be compiled into machine code in a format that may be loaded into a random access portion of the memory device 1106 and executed by the processor 1104, or source code may be loaded by another executable program and interpreted to generate instructions in a random access portion of the memory to be executed by a processor. The executable program may be stored in any portion or component of the memory device 1106. For example, the memory device 1106 may be random access memory (RAM), read only memory (ROM), flash memory, a solid state drive, memory card, a hard drive, optical disk, floppy disk, magnetic tape, or any other memory components.

The processor 1104 may represent multiple processors and the memory device 1106 may represent multiple memory units that operate in parallel to the processing circuits. This may provide parallel processing channels for the processes and data in the system. The local communication interface 1110 may be used as a network to facilitate communication between any of the multiple processors and multiple memories. The local communication interface 1110 may use additional systems designed for coordinating communication such as load balancing, bulk data transfer and similar systems.

While the flowcharts presented for this technology may imply a specific order of execution, the order of execution may differ from what is illustrated. For example, the order of two or more blocks may be rearranged relative to the order shown. Further, two or more blocks shown in succession may be executed in parallel or with partial parallelization. In some configurations, one or more blocks shown in the flow chart may be omitted or skipped. Any number of counters, state variables, warning semaphores, or messages might be added to the logical flow for purposes of enhanced utility, accounting, performance, measurement, troubleshooting or for similar reasons.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction or many instructions and may even be distributed over several different code segments, among different programs and across several memory devices. Similarly, operational data may be identified and illustrated herein within modules and may be embodied in any suitable form and organized within any suitable type of data structure. The operational data may be collected as a single data set, or may be distributed over different locations including over different storage devices. The modules may be passive or active, including agents operable to perform desired functions.

The technology described here may also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which may be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example and not limitation, communication media includes wired media such as a wired network or direct-wired connection and wireless media such as acoustic, radio frequency, infrared and other wireless media. The term computer readable media as used herein includes communication media.

Reference was made to the examples illustrated in the drawings and specific language was used herein to describe the same. It will nevertheless be understood that no limitation of the scope of the technology is thereby intended. Alterations and further modifications of the features illustrated herein and additional applications of the examples as illustrated herein are to be considered within the scope of the description.

Furthermore, the described features, structures, or characteristics may be combined in any suitable manner in one or more examples. In the preceding description, numerous specific details were provided, such as examples of various configurations to provide a thorough understanding of examples of the described technology. It will be recognized, however, that the technology may be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements may be devised without departing from the spirit and scope of the described technology.

What is claimed is:

1. A dental restoration method comprising:
under the control of one or more computer systems configured with executable instructions:
opening a file of a digital model of at least one tooth to undergo a dental restoration procedure;
selecting a direction of a cut to be performed in the dental restoration procedure;
selecting a bur to be used in the dental restoration procedure;
drawing a cut line to be performed in the dental restoration procedure with the bur;
generating a set of guide slots that are remotely located laterally from the cut line;
modeling a cutting guide based in part on the digital model, the direction of the cut, the bur, the cut line, and the guide slots; and
saving a file of the cutting guide.

2. The method of claim 1, the method further comprising 3D printing the cutting guide.

3. The method of claim 1, the method further comprising engraving a piece of information associated with the dental restoration procedure on the cutting guide.

4. The method of claim 3, wherein the piece of information includes a name of a dental professional performing the dental restoration procedure, a name of a patient having the dental restoration procedure, or the bur to be used in the dental restoration procedure.

5. The method of claim 1, further comprising verifying the dental restoration procedure based in part on the digital model, the direction of the cut, the bur, and the cut line.

6. The method of claim 5, further comprising viewing an X-ray computed tomography scan (CT scan) overlaid on the digital model.

7. The method of claim 6, wherein verifying the dental restoration procedure comprises viewing a warning when the cut encroaches upon tissue surrounding the at least one tooth as indicated by the CT scan.

8. The method of claim 1, wherein drawing the cut comprises placing a plurality of points within the digital model wherein the plurality of points connect to form at least one cut line, and the cut line is display on the digital model.

9. The method of claim 8, wherein the plurality of points are placed on an interior portion of the digital model and the cut line is displayed on a surface portion of the digital model.

10. A graphical user interface under the control of one or more computer systems, the graphical user interface comprising:
a digital model of at least one tooth;
an X-ray computed tomography scan (CT scan) overlaid on the digital model;
a dental restoration procedure selector to select a dental restoration procedure for the digital model;
an image direction setting tool to set an occlusal direction of the digital model;
a drawing tool to draw a cut line for the dental restoration procedure within the digital model;
a bur selection tool to select a bur for the dental restoration procedure within the digital model; and
an insertion axis selection tool to select an insertion axis for the bur for the dental restoration procedure within the digital model.

11. The graphical user interface of claim 10, further comprising a preview rendering tool to render a preview of the digital model with cuts applied based in part on the occlusal direction, the cut line, the bur, and the insertion axis.

12. The graphical user interface of claim 10, further comprising a display of a cut plane within the digital model.

13. The graphical user interface of claim 10, further comprising a cutting guide generation tool to produce a cutting guide based in part on the digital model, the occlusal direction, the cut line, the bur, and the insertion axis, wherein the cutting guide includes a set of guide slots that are remotely located laterally from the cut line.

14. The graphical user interface of claim 13, wherein a top portion of the cutting guide is substantially open above the at least one tooth for irrigation and forms a single continuous cut path along the cut line.

15. A non-transitory computer-readable medium storing a program causing a computer to perform a dental restoration method, the method comprising:
providing a digital model of at least one tooth;
setting an image direction for the digital model;
selecting a dental restoration procedure for the digital model;
drawing a cut line for the dental restoration procedure within the digital model;
selecting a bur for the dental restoration procedure within the digital model;
selecting an insertion axis for the bur for the dental restoration procedure within the digital model;
modeling a cutting guide for the dental restoration procedure within the digital model based in part on the image direction, the cut line, the bur, and the insertion axis; and
placing an undercut bump against the at least one tooth in the digital model to include the undercut bump on the cutting guide to help hold the cutting guide in place while performing the dental restoration procedure.

16. The non-transitory computer-readable medium of claim 15, the method further comprising generating a set of guide slots that are remotely located laterally from the cut line, wherein modeling the cutting guide is further based in part on the set of guide slots.

17. The non-transitory computer-readable medium of claim 15, the method further comprising overlaying an X-ray computed tomography scan (CT scan) on the digital model.

18. The non-transitory computer-readable medium of claim 17, the method further comprising:
rendering a preview of the digital model with cuts applied based in part on the image direction, the cut line, the bur, and the insertion axis; and
verifying the dental restoration procedure.

19. The non-transitory computer-readable medium of claim 18, wherein verifying the dental restoration procedure includes generating a warning if the cut line encroaches upon tissue surrounding the at least one tooth as indicated by the CT scan.

20. The non-transitory computer-readable medium of claim 15, wherein the digital model is stored in a standard tessellation language (STL) based file format.
